(19) United States
(12) Patent Application Publication
(10) Pub. No.: US 2016/0350967 A1
(43) Pub. Date: Dec. 1, 2016

(54) DYNAMIC ADJUSTMENTS FOR AUGMENTED, MIXED AND VIRTUAL REALITY PRESENTATIONS

(71) Applicant: Cable Television Laboratories, Inc., Louisville, CO (US)

(72) Inventor: Eric Klassen, Lafayette, CO (US)

(21) Appl. No.: 15/170,209

(22) Filed: Jun. 1, 2016

Related U.S. Application Data
(60) Provisional application No. 62/169,023, filed on Jun. 1, 2015.

(51) Int. Cl. G06T 15/60; G06T 19/00

(52) U.S. Cl. CPC G06T 15/60; G06T 19/006; G06T 2215/12; G06T 2215/16

(57) ABSTRACT

Dynamically adjusting presentations associated with augmented, mixed and/or virtual reality is contemplated. The dynamic adjustments may be made to augment sensory influences on a user, such as but not necessarily limited to dynamically adjusting lighting effects of the presentation to compensate for changes in direct and/or indirect luminosity or other lighting related affects.

### CROSS-REFERENCE TO RELATED APPLICATIONS

This application claims the benefit of U.S. provisional Application No. 62/169,023 filed Jun. 1, 2015, the disclosure of which is incorporated in its entirety by reference herein.

### TECHNICAL FIELD

The present invention relates to dynamically adjusting presentations associated with augmented, mixed and/or virtual reality, such as but not necessarily limited to dynamically adjusting lighting effects of the presentation to compensate for changes in direct and/or indirect luminosity or other lighting related affects.

### BACKGROUND

Augmented, mixed and virtual reality generally relate to replicating visual, tactile, auditory and/or other sensory experiences for a user when the user is either not actually experiencing the corresponding sensation in the real or physical world or experiencing the corresponding sensation in a modified form. Augmented reality (AR) is understood to generally occur at one end of an artificial spectrum where the real world environment of a user is supplemented with non-real or manufactured sensations. Virtual reality (VR) is understood to generally occur at an opposite end of the artificial spectrum where an entirety of the real world environment of a user is replaced with non-real or manufactured sensations. Mixed reality (MR) is understood to generally occur somewhere between the two ends of the artificial spectrum where physical and digital objects interact with the real and non-real environment of the user to provide a supplemented and/or supplanted experience. One non-limiting aspect of the present invention contemplates dynamically adjusting the presentations associated with AR, MR and/or VR as a function of actual events occurring in the real world and/or forecasted or hypothetical events generated to mimic real-world events, such as to maximize authenticity of non-real or manufactured sensations associated with AR, MR and/or VR according to the real-world influences and effects.

### BRIEF DESCRIPTION OF THE DRAWINGS

FIG. 1 illustrates a reality device for generating and dynamically adjusting augmented reality (AR), mixed reality (MR), virtual reality (VR) and/or other enhanced reality views in accordance with one non-limiting aspect of the present invention.

FIG. 2 illustrates an AR view of the real area generated with the AR device in accordance with non-limiting aspect of the present.

FIG. 3 illustrates a schematic of the AR device in accordance with one non-limiting aspect of the present invention.

FIG. 4 illustrates a lighting map generated with the mapping device in accordance with one non-limiting aspect of the present invention.

FIG. 5 illustrates estimating lighting influences on an AR object in accordance with one non-limiting aspect of the present invention.

FIG. 6 illustrates a diagram associated with generating a shadow as a lighting effect for an AR object in accordance with one non-limiting aspect of the present invention.

FIGS. 7a-7b illustrate diagrams associated with dynamically adjusting a shaped of a shadow for an AR object in accordance with one non-limiting aspect of the present invention.

FIG. 8 illustrates a flowchart for a method of dynamically adjusting AR views in accordance with one non-limiting aspect of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

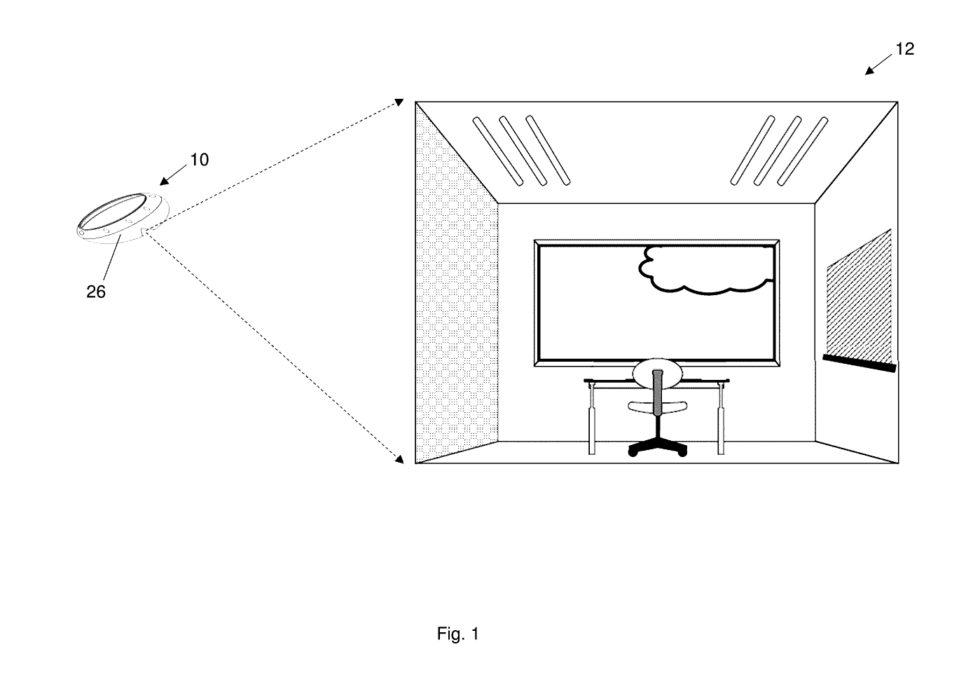

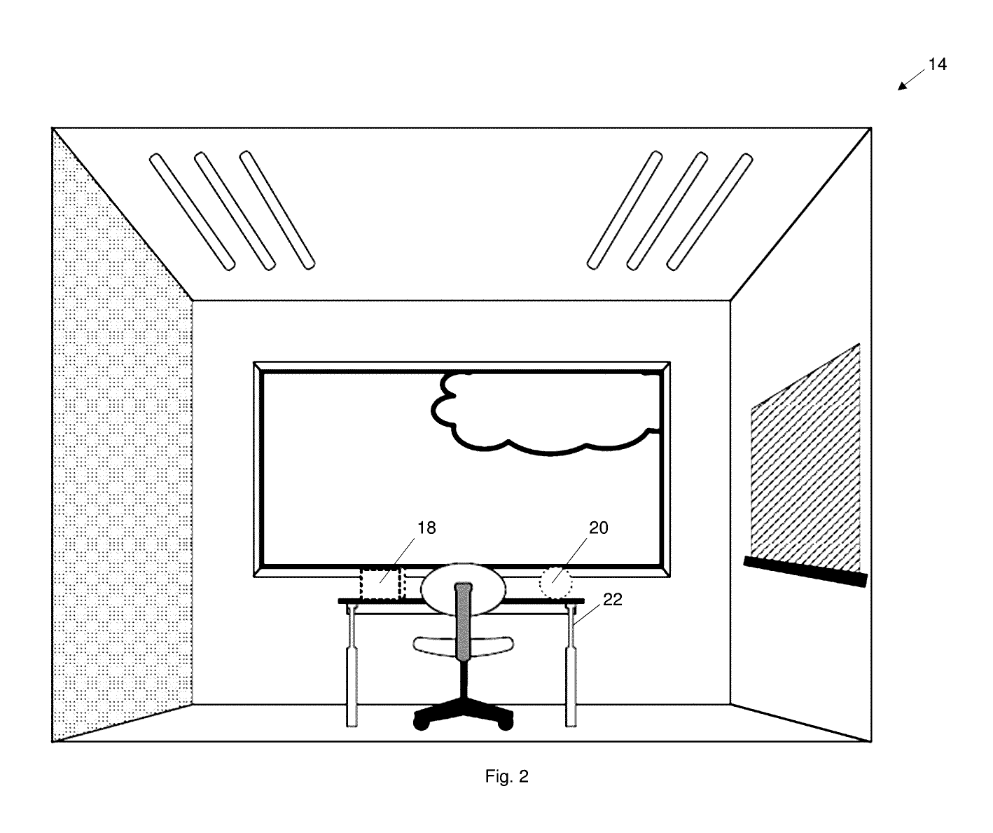

FIG. 1 illustrates a reality device 10 for generating and dynamically adjusting augmented reality (AR), mixed reality (MR), virtual reality (VR) and/or other enhanced reality views for a real or physical world/area 12 in accordance with one non-limiting aspect of the present invention. The reality device 10 may be characterized as an AR device, a MR device and a VR device when operating to facilitate respectively generating AR views, MR views and VR views. FIG. 2 illustrates an AR view 14 of the real area 12 generated with the AR device 10 in accordance with non-limiting aspect of the present. The AR view 14 may be characterized by the AR device 10 augmenting or otherwise enhancing the real area 12 and/or the real objects, features, elements, etc. therein with one or more AR objects 18, 20. The AR objects may correspond with any non-real, digital, sensory or related object, media, representation, sensory effect, etc. added to the AR view 14 with the AR device 10 and are shown for exemplary non-limiting purposes to correspond with a first object 18 and a second object 20 presented relative to a desk 22 and other real/physical objects included the real area 12. (The physical/real objects are shown in solid lines and the non-real/digital AR objects are shown in dashed lines.)

The system is predominately described for exemplary non-limiting purposes with respect to generating the illustrated AR view 14 as such views are particularly illustrative of the need to dynamically adjust the associated augmentation in order to maximize authenticity of the presentation according to the dynamic, variable and changing sensory influences associated with the real/physical area and objects therein. The sensory influences from the real objects may result from auditory sources, visual/lighting sources, tactile sources, aromatic sources and other sources producing sensory responses or perceptions within a person subjected to the corresponding AR view. While descriptively focused on the AR view 14, the present invention fully contemplates its use and application in facilitating and managing dynamic adjustments and augmentations for MR views, VR views or other enhanced views where the authenticity of the corresponding view may be similarly susceptibility to discontinuities, disruptions or interferences resulting from sensory influences of the real objects in the real area 12 dynamically changing over time.

FIG. 1 illustrates the AR device 10 being configured in accordance with one non-limiting aspect of the invention as a wearable device capable of being worn on a person within view of the real area 12. The AR device 10 is shown to be configured as a headset shaped to position a see-through screen, lens, shield, etc. 26 in front of one or more eyes of the wearer to facilitate displaying image frames or other visual representations while also allowing the user to simultaneously view the real area 12 therethrough. The AR device 10 may include capabilities sufficient to facilitate projecting static and/or moving images and/or video frames on the screen 26 within sight of the user and/or to otherwise electronically control the screen 26 to display images, e.g., electronic circuitry may be used to physical alter or adapt the screen 26 to display images as opposed to having the images projected thereon. The AR device 10 is shown to be a wearable for exemplary non-limiting purposes as the present invention fully contemplates the AR device 10 having other configurations, including non-wearable configurations and/or configurations where a remote entity in wired or wireless communication therewith is able to perform the processing described herein on behalf of the AR device 10 such that the AR device 10 may only need to receive signal associated with generating the AR objects.

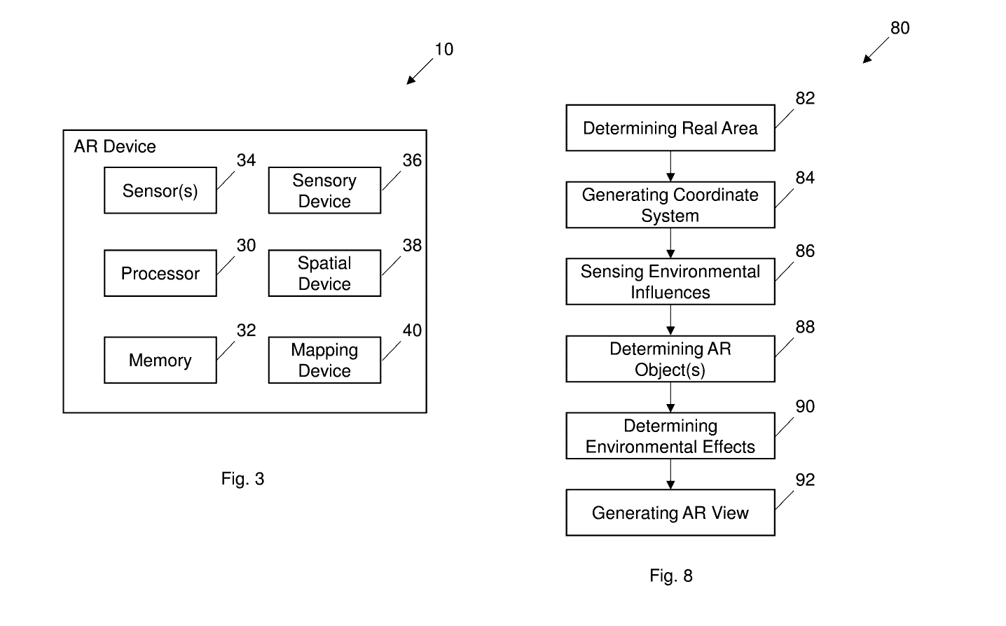

FIG. 3 illustrates a schematic of the AR device 10 in accordance with one non-limiting aspect of the present invention. The AR device 10 may include a processor 30 or other logically functioning construct having capabilities sufficient to facilitate executing non-transitory instructions stored on a memory or other computer-readable medium 32 associated with performing and coordinating the operations contemplated herein. The AR device 10 may include electronic components and circuitry to facilitate hardware and software implementation of the contemplated operations as one having ordinary skill in the art will appreciate. The AR device 10 is shown for descriptive purposes as including one or more sensors 34, a sensory device 36, a spatial device 38 and a mapping device 40. The sensors 34 may correspond with a lighting sensor, a sound sensor, a temperature sensor, an aromatic sensor or other sensor/measurement device having capabilities sufficient to determine sensory influences of the real objects, sources or elements present in the real area 12 and/or the person. The sensors 34 may also include capabilities to detect, measure, test, etc. non-human sensory influences the real area 12 and/or on the person, such as with wireless signaling, non-visible light or magnetic waves, global positioning, angular direction and other capabilities associated with defining and assessing the metes and bound and nature of the objects in the real area 12.

A sensory device 36, such as but not necessary limited to a projector, video decoder or other image processing device, may be included to facilitate displaying images associated with image-based AR objects to the person on the screen 26 or other suitable interface included on or independent of the AR device 10. One non-limiting aspect of the present invention contemplates the AR device 10 being in wired or wireless communication with a content source or entity having capabilities sufficient to facilitate generating the images forming the AR objects and/or software or other on-sight capabilities sufficient to retrieve or otherwise generate the images from information and other data stored on the memory 32, e.g., an application may execute on the AR device 10 whereby the person may dictate or control the AR objects according to verbal and non-verbal commands/gestures to produce an interactive AR view 14. The sensory device 36 may comprise multiple devices and/or capabilities sufficient to facilitate directly or indirectly providing other sensory effects, such as through the delivery or control of tactile, auditory and/or aromatic activities or capabilities of the AR device 10, and/or the sensory device 36 may rely on remote processing entities to perform some or all of the functions, operations, processes, etc. described herein.

A spatial device 38 may be included to facilitate generating spatial relationships between the AR device 10 and the real objects and other elements within the real area 12. The spatial device 38 may include capabilities sufficient to facilitate determining a relative distance and position of the real objects to the AR device 10, such as with establishment of a coordinate system centered at the AR device whereby X, Y, Z or other suitable coordinates may be used to assess relative positioning of the real objects to the AR device 10. The spatial device 38 may also be capable of establishing relative positioning using other coordinate infrastructures, such as using global positioning, triangulation, etc. whereby relative positioning of the real objects may be similarly established for purposes of assessing their spatial relation to the AR device 10 or other location from which to the AR view 14 is depicted, e.g., the AR device 10 may be utilized to generate AR views 14 centered or directed from other, remote locations. One non-limiting aspect of the present invention contemplates the spatial device 38 operating in cooperation with the other capabilities of the AR device 10 to facilitate relating the sensory inputs and outputs of AR device 10 according to the relative positioning established for the real objects with the spatial device 38, i.e., the inputs/outputs may be adjusted according to the relative positioning information.

A mapping device 40 may be included to facilitate mapping or otherwise calibrating the data and other information collected with the sensors 34, the spatial device 38 and/or other features of the AR device 10. The mapping device 40 may generate maps, data, information and the like regarding sensory influences within the real area 12, such as to facilitate keeping track of luminosity associated direct and/or indirect light sources, object movement, object characteristics (e.g., size, shape, etc.) and virtually any other data collected with the AR device, particularly data or influences that may change over time. One non-limiting aspect of the present invention contemplates the mapping device periodically memorializing the sensory and other real object related influences for purposes of tracking the changes associated therewith in order to facilitate the dynamic augmentation contemplated by the present invention. The mapping device 40 may be configured to generate a map or other construct of the corresponding data for storage in the memory 32 and/or for sharing or input to other devices or functions of the AR device 10 to facilitate tailoring the operations associated therewith according to the mapped information.

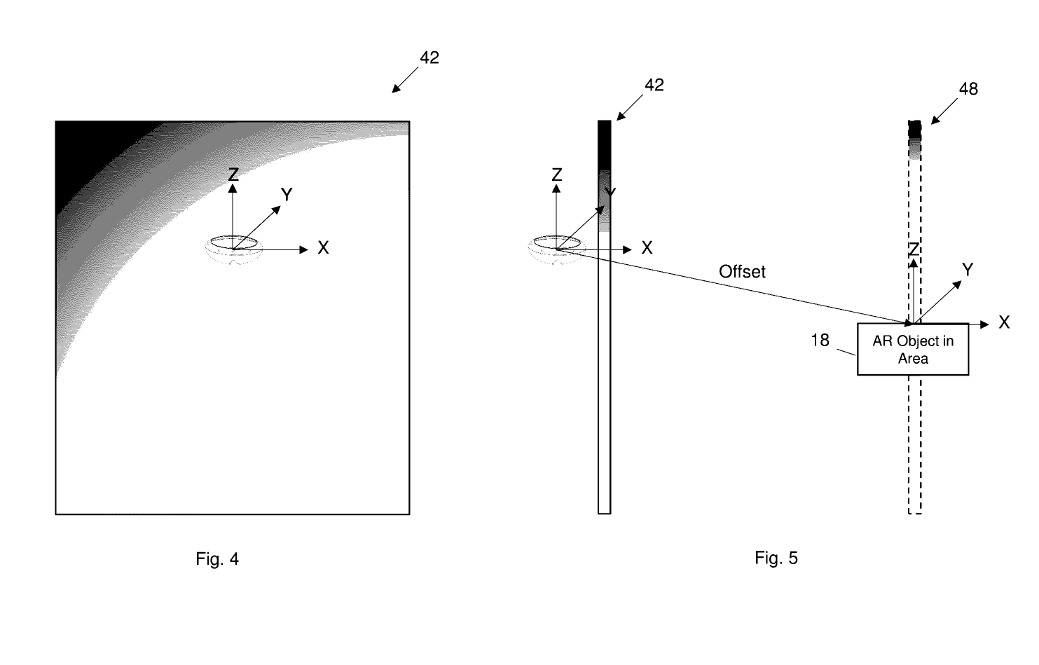

FIG. 4 illustrates a lighting map 42 generated with the mapping device 40 in accordance with one non-limiting aspect of the present invention. The lighting map 42 is shown as a color-temperature, light graph sufficient for indicating a color and an intensity of light within the real area reaching a light sensor included as one of the AR device sensors 34. The spatial device 38 may cooperate with the mapping device 40 to facilitate generating the light graph relative to the coordinates system centered at the AR device 10 so as to generate a calibration of the light within the real area 12 from a perspective of the person wearing the AR device 10. The light map 42 may be dynamically updated and periodically stored in the memory 32 to facilitate dynamically mapping lighting influence in the real area 12. The lighting map 42 may utilize an approximately 360° stereoscopic and calibration capabilities of the AR device sensors 34 to facilitate recording the lighting relative to the 3D space of the real area 12 generated with the spatial device 38. The mapping device 40 may thereafter capture/generate calibration readings for the light sources and fill surfaces in real time to accurately reflect dynamic lighting alterations in the real area 12.

As shown in FIG. 1, the real area 12 may include a plurality of light sources emitting light into the real area where the corresponding light waves may collide or become incident with physical objects to illuminate objects, cast shadows, provide in-fill in otherwise generate direct and indirect lighting influences. The real area 12 is shown for exemplary purposes to include exterior light sources, such as the sun, moon, clouds, sky etc., interior light sources such as fluorescent or incandescent light bulbs, and reflective light sources, such as dark and light colored walls. The real area 12 is illustrated for exemplary purposes to correspond with an office or room having a window to the outside world and with metes and bounds constrained with corresponding structures, i.e., a ceiling, a floor and a plurality of walls. This type of interior or constrained real area 12 is shown for descriptive purposes as the present invention fully contemplates its use and application in facilitating AR views 14 for unconstrained areas viewable through the screen 26 or other interface of the AR device 10. As one having ordinary skill in the art will appreciate, the interaction and interplay of the light sources with the real objects may vary depending on the color, shape, and other characteristics associated therewith such that any number of lighting influences may be produced and represented in the lighting map 42.

The mapping device 40 may be configured to facilitate generating the lighting map/environment 42 by gathering the following data:

1. Position of light sources, e.g., windows, lights, doors, sun, sky, moon

2. Color temperature from each source, e.g., outdoor light may be higher temp, especially if overcast, indoor light may be lower temp, especially if from an incandescent bulb, and multiple color temps may be applied to the AR media/objects as windows and indoor lights make up the lighting map

3. Luminosity, or intensity of light, or nits, from each source

4. Degree of Diffusion, e.g., hard light: direct light that casts a clean shadow (clear day at noon), soft light: indirect light that casts soft shadows or no shadows (overcast day at noon), and a window during an overcast day in a dimly lit home will cause hard light due to the lower light contrast inside

5. Fill amount from reflective surfaces, e.g., dark wall or material=low fill, white wall or material=medium fill, and mirror or highly reflective material=highest fill

The following table indicates luminosity data, values and other parameters that may be optionally included within the lighting map 42 and/or associated therewith to facilitate dynamically mapping the lighting in accordance with the present invention:

| Quantity | | Unit | | Dimension | |
|---|---|---|---|---|---|
| Name | Symbol | Name | Symbol | Symbol | Notes |
| Luminous energy | Qv | lumen second | lm · s | T · J | Units are sometimes called talbots. |
| Luminous flux/luminous | φᵥ | lumen (= cd · sr) | lm | J | Luminous energy per unit time. |
| power | | | | | |
| Luminous intensity | Iᵥ | candela (= lm/sr) | cd | J | Luminous power per unit solid angle. |
| Luminance | Lᵥ | candela per | cd/m² | L⁻² · J | Luminous power per unit solid angle per |
| | | square metre | | | unit projected source area. Units are |
| | | | | | sometimes called nits. |
| Illuminance | Eᵥ | lux (= lm/m2) | lx | L⁻² · J | Luminous power incident on a surface. |
| Luminous exitance/ | Mᵥ | lux | lx | L⁻² · J | Luminous power emitted from a surface. |
| luminous emittance | | | | | |
| Luminous exposure | Hᵥ | lux second | lx · s | L⁻² · T · J | |
| Luminous energy density | ωᵥ | lumen second per | lm · s · m⁻³ | L⁻³ · T · J | |
| | | cubic metre | | | |
| Luminous efficacy | η | lumen per watt | lm/W | M⁻¹ · L⁻² · T³ · J | Ratio of luminous flux to radiant flux or |
| | | | | | power consumption, depending on context. |
| Luminous efficiency/ | V | | | 1 | |
| luminous coefficient | | | | | |

FIG. 5 illustrates estimating lighting influences on an AR object 18 in accordance with one non-limiting aspect of the present invention. The sensory device 36 responsible for generating the AR object 18 may cooperate with the mapping device 40 and the spatial device 38 to a corresponding or relative lighting map 48 to estimate lighting influences on the AR object 18 within the real area 12, i.e., lighting effects expected to influence the AR object 18 if the AR object 18 was physically added to the real area 12. One non-limiting aspect of the present invention contemplates maximizing authenticity of the AR view 14 by adding lighting effects to the AR object 18 to represents how the various light sources would influence the AR object 18 if the AR object was a real object. The lighting effects added to the AR object 18 may be calibrated from the lighting map 42 so as to provide a realistic representation of the AR object 18 from the point of view of the person wearing the AR device 10. While the present invention fully contemplates providing other lighting and non-lighting effects to the AR object 18 as a function of the data collected with the AR device 10, one non-limiting aspect of the present invention contemplates defining a shape, intensity or other characteristics of a shadow associated with the AR object to produce a realistic representation of the AR object 18 depending on an offset or relative positioning of the AR object 18 to the AR device 10.

The offset or positional differentiation between the AR device 10 and the AR object 18 may be utilized to facilitate relating the lighting map 42 to the lighting influences 48 on the AR object 18 without having to actually measure the lighting influences in the real area 12 at a position corresponding with the AR object 18, i.e., the measurements taken at the position of the AR device 10 may be extrapolated to determine lighting influences 48 at the AR object 18 without having to similarly sense lighting influences at a related position in the real area 12. The estimated lighting influences 48 may be determined by generating weighting values as a function of differences in the X, Y and Z positional coordinates for the AR device 10 and the AR object 18 and then using those weighting values to correspondingly adjust the lighting map 42. The weighting values may be used to generate the estimated lighting map 48 centered at the AR object 18 or other relationships that can then be processed to determine the shape, intensity or other characteristic of the shadow or other feature applied to the AR object in order to maximize the authenticity of its presentation within the AR view. One particular aspect of the present invention contemplates dynamically estimating the lighting influences 48 in order to continuously adjust the lighting effects provided for the AR object so as to authentically track actual changes of the light sources within the real area over time.

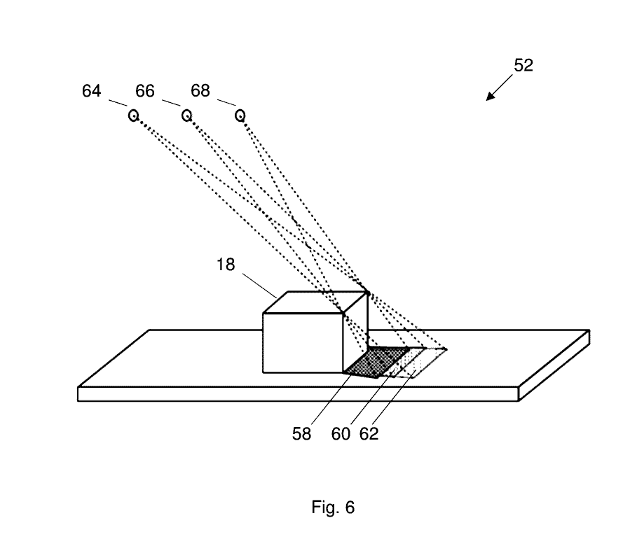

FIG. 6 illustrates a diagram 52 associated with generating a shadow 54 as a lighting effect for the AR object 18 in accordance with one non-limiting aspect of the present invention. The lighting effect 54, i.e., shape of a shadow, is shown for exemplary non-limiting purposes to include a first portion 58, a second portion 60 and a third portion 62 (e.g., first, second, and third shadows) resulting from a corresponding one of a first light source 64, a second light source 66 and a third light source 68 emitting light into a position of the real area 12 in which the AR object 18 is to augment the user experience, i.e., through direct, indirect or reflected light waves. The lighting influences of the first, second and third light sources 64, 66, 68 may be estimated from the lighting map 42 (e.g., see FIG. 5) generated with the mapping device 40 according to the processes described above. While additional lighting influences, such as surface or skin color, light intensity, etc., may affect presentation of the AR object 18, the illustrated shadows 58, 60, 92 are shown for exemplary purposes to demonstrate capabilities of the present invention to relate lighting influences sensed at the AR device 10 to presentation of the AR object 18 within the AR view 14 when the AR object 18 is positioned at a location offset from the AR device 10 sensing the lighting influences within the real area 12.

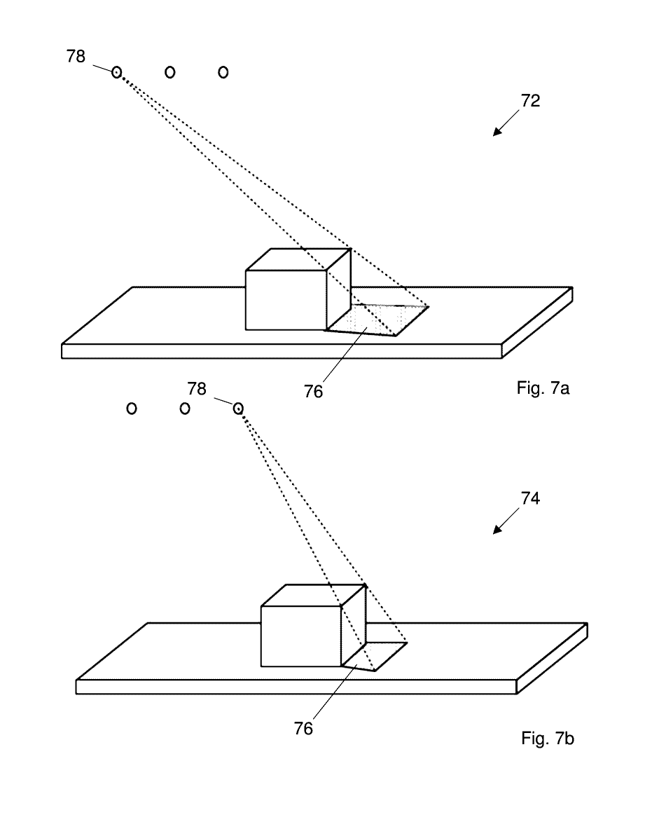

FIGS. 7a-7b illustrate diagrams 72, 74 associated with dynamically adjusting a shaped of a shadow 76 for the AR object 18 in accordance with one non-limiting aspect of the present invention. The adjustment relates to changing a lighting effect on the AR object 18, i.e., the shape of the shadow 76 as cast on a real object, as a light source 78 in the real area changes position from a first position (FIG. 7a) to a second position (FIG. 7b) and/or as function of the light associated therewith shifting due to reflection, object movement, etc. An angle of incidence (dashed lines) of the light source 78 with the AR object 18 may be determined at a first instance in time corresponding with the first position and at a second instance in time corresponding with the second position. The angles of incidence may thereafter be estimated from corresponding lighting maps to dynamically adjust the shadow 76 in real-time as the light source moves. The angle of incidence is shown to decrease with movement of the lighting source 78 such that the shape of the shadow becomes smaller as the lighting source 78 moves in a rightward direction. While the shape of the shadow 76 is shown to be dynamically adjusted as a function of light source movement, the color, intensity, in-fill and other lighting and non-lighting influences on the AR object 18 may be similarly updated without deviating from the scope and contemplation of the present invention.

The lighting effects necessary to authentically and dynamically reflect real area changes within a corresponding AR view 14 may be determined by relating the lighting map 42 to a desired position of the AR object 18 in the above-described manner, i.e., determining the lighting effects based on lighting maps 42 generated from a prior instance in time. One non-limiting aspect of the present invention contemplates the sensory device 36 generating the AR object 18 and attendant lighting effects (e.g., shadows, skin color, etc.) having capabilities sufficient to facilitate essentially real-time updates to the lighting effects as the real objects move, change, etc. in the real area, such as through the continuous projection of corresponding images onto the screen 26. The sensory device 36 may facilitate the real-time lighting effect updates by determining the dynamic adjustments and processing the corresponding AR object 18 and/or lighting effect changes at image frame refresh rates quicker than the human eye can ascertain (e.g., 30/60 fps) such that the dynamic adjustments effectively occur in real-time. In this manner, the present invention can provide a reactionary adjustment to the AR view 14 and the AR objects 18, lighting effects and other digitally fabricated sensory features associated therewith as real objects enter, leave or otherwise disrupt the real view.

One non-limiting aspect of the present invention contemplates dynamically changing to the AR view 14 and/or the AR objects 18 and sensory features associated therewith in anticipation of changes in the real area 12, e.g., in anticipation of the light source actually moving in the rightward direction illustrated above. The anticipatory adjustments contemplated by the present invention may be facilitated by projecting or otherwise forecasting changes to the real area 12 prior to the changes occurring so that the corresponding AR view adjustments can be implemented in concert with the anticipated activity. With respect to the light source 78 moving the rightward direction, the delay associated with generating a lighting map 42 and attendant processing to determine influences on the AR object 18 can be ameliorated by forecasting the movement. The sensory device 36 may be configured to anticipate the movement as a function of prior positional changes in the lighting source 78, its current speed of movement/acceleration and other operating history so as to estimate the corresponding image frame refresh/adjustments necessary to provide an authentic lighting effect or other sensory change to the AR object 18 prior to actually/physically detecting the corresponding change in the real area.

One non-limiting aspect of the present invention contemplates buffering or otherwise storing previously generated lighting maps 42 within the memory for subsequent use in dynamically adjusting AR views 14. The stored lighting maps 42 may be sufficient to represent the lighting influences and other influences of the real objects in the real area 12 at a preceding instance in time. Multiple lighting maps 42 may be stitched or pieced together to generate the contemplated information for the corresponding real area 12 in the event the real area 12 being processed for AR augmentation fails to coincide with one of the stored lighting maps 42. Characteristics of the real area 12 may be assessed to determine an appropriate one or more of the stored lighting maps 42 to be processed when facilitating the dynamic update, such as based on a time of day, type of day (rainy, sunny, etc.) and the like, optionally with averaging, weighting or other scaling being used to combine multiple light maps 42. The one or more stored lighting maps 42 may then be used to generate AR object 18 and effect changes, such as when a current lighting map is unavailable and/or when changes in the real area 12 occur too quickly or in a manner likely to be unsettling the AR device user. A stored lighting map 42 can be used in place of a current or newly generated lighting map 42 when the current lighting map 42 reflects sudden real object changes or other influences that may be unsettling, such as when a rate of movement, a rate of luminosity or other rate of change in the real object exceeds a threshold, a design parameter or other metric.

FIG. 8 illustrates a flowchart 80 for a method of dynamically adjusting AR views in accordance with one non-limiting aspect of the present invention. The method may be embodied as a plurality of non-transitory instructions stored in the memory 32 or other computer-readable medium and executable with the processor 30 to facilitate controlling the AR device 10 or other suitable device to implement the processes and operations contemplated herein. While the method is described with respect to adjusting AR views 14, i.e., views as they are actually/physically being experienced through the screen 26 or other device associated with a user, the present invention fully contemplates its use and application in adjusting MR, VR or other views amenable to the dynamic augmentation is described herein. The method described herein may be particular beneficial in facilitating real-time or approximately real-time updates to AR views as a function of changes occurring in an environment associated therewith, such as to enhance authenticity of the AR view according to as actual or physical events occur. The capability to perform the contemplated adjustments in a dynamic manner may be helpful in accounting for unscheduled or unplanned real-world activities, particularly when the activities are random or unforeseeable.

Block 82 relates to determining a real/physical area or view to be augmented with one or more AR sensory effects to correspond with an environment being viewed through the screen of a user wearing the AR device. The AR device may include capabilities sufficient to assess or experience areas in the real world beyond the periphery of the user's vision, e.g., the AR device may include 360° capabilities, such that the real view may be associated with a wider viewing angle. Block 82 generally relates to determining at least a portion of the real area accessible to the AR device for which augmentation is desired. Optionally, the AR device may automatically generate the real view to coincide with movements of the wearer, such as by changing the view in response to the user turning their head side-to-side or up and down, and/or the real view may be selected from instructions received from a remote processing entity or locally from the wearer using gestures or other suitable inputs. The real view and the real area associated therewith is intended for exemplary non-limiting purposes to generally relate to processes associated with generating the view desired for augmentation, and as such, is not necessary limited to areas being physically seen or actually being exposed to the user wearing the AR device.

Block 84 relates to determining a coordinate system for the real area sufficient to facilitate relating real object positioning relative to the AR device. The coordinate system may be based on local information, signaling or other data exchange between the AR device in the real area (radar, infrared, triangulation, etc.), non-local information, such as global positioning, or other information (user-specified). The coordinate system may be continuously updated and maintained to reflect ongoing spatial relationships between the AR device and virtually any source, element, object or influence within the real area, which are generally characterized herein for non-limiting purposes as real objects, so as to enable those real objects to be tracked or otherwise monitored for changes or other alterations in their state(s) of being. The coordinate system may also include establishing dimensions, vectors and other values to describe are characterized changes or the lack of changes in the AR objects. Timestamps or other temporal references may be associated with the coordinates system processing to facilitate memorializing real object variations relative to a timeline so that consistent reference points can used to assess changes.

Block 86 relates to sensing environmental influences within the real area having capabilities sufficient to effect authenticity of the AR view. The environmental influences may be distinguished from the above described coordinate system relationships as instead focusing on operating capabilities of the real objects to impart sensory effects to the real area. The environmental influences may encompass virtually any type of trackable characteristic that the real objects may exhibit for influencing the user of the AR device, i.e., any sensory effect that the user may experience or that may require assessment in order to provide an authentic AR experience. Like the coordinate system information, the environmental influences may be continuously tracked and stored in the memory to track influences over time. As described above with respect to FIG. 4, one non-limiting aspect of the present invention contemplates characterizing at least a portion of the environmental influences within a lighting map sufficient to represent light-based influences on the real area as measured at the AR device or with another device associated with the real area (e.g., the lighting map may be generated with a standalone device in area and/or in communication with the AR device or a remote entity having access to the real area).

Block 88 relates to determining one or more AR objects to be included within the AR view. The AR objects may correspond with digital or non-physical objects projected onto the screen or otherwise associated with the AR view for purposes of augmenting the real area. The AR objects are predominant described with respect to being static or moving images resulting from one or more video or image frames for exemplary non-limiting purposes as the present invention fully contemplates generating the AR objects as any sensory effect capable of being artificially provided or manufactured for the user. The determination of the AR objects may include determining a positional relationship of the AR objects to the AR device based on the coordinate system generated in Block 84 so as to determine relative positioning within the real area as if the AR objects where physically present therein. The presented AR objects may vary over time or be selected/controlled as a function of any number of inputs, including those received from the user or a remote processing entity in communication with the AR device.

Block 90 relates to determining environmental effects on the AR objects at least in part on the sensing performed in Block 86. A mapping or other relational process may be undertaken in order to assess how the environmental influences will affect the presentation of the desired AR objects. The determining environmental effects may be based partially on the type of AR object(s) such that the environmental effects influencing presentation of a static AR object, such as the box is illustrated above in FIG. 2, may be different than the environmental effects in influencing presentation of an acoustical or aromatic AR object, i.e., the lighting influencing a shadow of an AR box or other AR visual may be less relevant to or unnecessary for assessment when facilitating generation of non-image based AR objects. One non-limiting aspect of the present invention contemplates dynamically adjusting shadows, skin/surface coloring and other luminous effects for the AR object according to lighting maps and dynamic changes of light sources or influences associated with the real area.

Block 92 relates to generating the AR view of the real area to include one or more AR objects. The AR objects may be generated to manufacture or otherwise augment a user's view the real area using virtually any sensory mechanism of the AR device. One non-limiting aspect of the present invention contemplates generating moving or static images, video frames, etc. for viewing through a screen of the AR device and dynamically adjusting the presentation thereof as the user changes a viewing direction of the screen and/or objects within the real area people therethrough change. The lighting of the are object may be effected by different sources of light, i.e. when there's three lights on the box, it would be roughly 3× more illuminated than a single light, and some mixing would happen on the different surfaces. Dynamic adjustments may be made to the AR media according to the lighting maps or other real area related variations and/or variations introduced by other AR objects, e.g., an AR object may itself act as a light source requiring dynamic update to other AR objects as they are light source changes

By perpetually applying the lighting maps and other factors associated with real area or AR variations onto the AR media skin, the AR media displays dynamic changes according to changes in the surrounding environment. Once the map is generated, the lighting can then rendered onto the skin of the AR media. Two exemplary scenarios for needing dynamic lighting:

1. Map Change: if window blinds are pulled open during daytime, then the rush of light is recorded and applied in real time to the media.

2. Media Positional Change: if the AR media moves to new positions in the map, lighting conditions change and real time lighting adjustments are needed. Other factors include, but are not limited to: media changing shape, media changing hue or texture, and creative choices to tweak media's lighting unnaturally

Additional light applications to consider:

1. Media as separate light sources in the augmented frame. There are several instances where media can be a separate light source, thereby lighting other media and map surfaces in the augmented frame. For example, an augmented spotlight shines onto an augmented spinning disco ball, which in turn casts augmented moving highlights across the 3D map surfaces. To realistically map the disco ball highlights to the 3D map, the position/reflection of the disco ball mirrors must be defined, and the texture/color/reflection of each surface in the 3D map must be defined.

2. If the 3D viewing area is completely dark, a real-time map cannot be generated and an archival map of the area must be accessed (unless infrared light is used on the stereoscopic cameras which is possible). For example, an augmented light bulb is the only light source in a pitch-black room: the stereoscopic cameras cannot see surfaces to map in real-time. In this scenario, an archive lighting map of the room may be used to generate a high confidence guess of un-moved surfaces such as the floor, walls, ceiling, and large furniture.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A non-transitory computer-readable medium having a plurality of non-transitory instructions executable with a processor of an augmented reality (AR) device to facilitate presenting an AR view of a real area, the AR device having a housing shaped to position a see-through screen in front of one or more eyes of a person, the AR device having a light sensor configured to sense luminosity within the real area proximate the person, the AR device having an image generation device sufficient to facilitate displaying or more image frames on the screen, the non-transitory instructions being sufficient to facilitate:
generating a first lighting map of the real area based on a first luminosity data determined for at least a portion of the real area with the light sensor at a first instance in time;
determining an AR object to be displayed on the screen with the image generation device in order to present the AR view of the real area at a second instance in time occurring after the first instance; and
determining a first lighting effect to be displayed on the screen with the image generation device for augmenting the AR object in the AR view at the second instance based at least in part on the first lighting map.

2. The non-transitory computer-readable medium of claim 1 further comprising non-transitory instructions sufficient for:
determining the first lighting effect to include a first shadow; and
determining a first shape and/or a first intensity of the first shadow based at least in part on the first lighting map.

3. The non-transitory computer-readable medium of claim 2 further comprising non-transitory instructions sufficient for:
determining the real area to include at least a first light source and a second light source at the first instance based at least in part on the first lighting map;
determining a first angle of incidence with the AR object for a first light emitted from the first light source based at least in part on the first lighting map;
determining a second angle of incidence with the AR object for a second light emitted from the first light source based at least in part on the first lighting map; and
determining the first shape of the first shadow based at least in part on the first and second angles such that the first shadow represents how the first and second light sources would influence a real shadow for the AR object if the AR object was real.

4. The non-transitory computer-readable medium of claim 3 further comprising non-transitory instructions sufficient for:
generating a second lighting map of the real area based on a second luminosity data determined for at least a portion of the real area with the light sensor at a third instance in time occurring after the second instance;
determining the AR view at a fourth instance in time occurring after the third instance to require the AR object to be appear stationary at least in so far as the AR object appearing in the AR view at the second and fourth instances without changing position; and
determining a second lighting effect to be displayed on the screen with the image generation device for augmenting the AR object at the fourth instance based at least in part on the second lighting map;
determining the second lighting effect to include a second shadow;
determining a second shape of the second shadow based at least in part on the second lighting map;
determining the real area to include the first and second light sources at the third instance based at least in part on the second lighting map;
determining a third angle of incidence with the AR object for a third light emitted from the first light source based at least in part on the second lighting map, including determining the third angle to match the first angle due to a position of the first light source being the same at the first and third instances;
determining a fourth angle of incidence with the AR object for a fourth light emitted from the second light source based at least in part on the second lighting map, including determining the fourth angle to differ from the second angle due to a position of the second light source being different at the first and third instances; and
determining the second shape of the second shadow based at least in part on the third and fourth angles such that the second shape differs from the first shape by an amount sufficient to cause the second shadow to appear differently in the AR view than the first shadow.

5. The non-transitory computer-readable medium of claim 4 further comprising non-transitory instructions sufficient for:
generating a first image frame to be displayed on the screen with the image generation device at the second instance to facilitate presenting the AR view to include at least the AR object and the first shadow; and
generating a second image frame to be displayed on the screen with the image generation device at the fourth instance to facilitate presenting the AR view to include at least the AR object and the second shadow.

6. The non-transitory computer-readable medium of claim 5 further comprising non-transitory instructions sufficient for:
determining the first and second lighting effects to respectively include a first coloring and a second coloring, the first coloring being determined from the first lighting map to represent a coloring influence of the first and second light sources on the AR object at the first instance, the second coloring being determined from the second lighting map to represent a coloring influence of the first and second light sources on the AR object at the second instance, including determining the second coloring to be different from the first coloring due to the position of the second light source being different at the first and third instances;
generating the first image frame to include the first coloring being applied to the AR object; and
generating the second image frame to include the second coloring being applied to the AR object.

7. The non-transitory computer-readable medium of claim 1 further comprising non-transitory instructions sufficient for:
determining the first lighting effect to be a first shadow associated with a light source positioned at a first location within the real area at the first instance;
generating a first image frame to be displayed on the screen with the image generation device at the second instance to facilitate presenting the AR view to include at least the AR object and the first shadow;
generating a second lighting map of the real area based on a second luminosity data determined for at least a portion of the real area with the light sensor at a third instance in time occurring after the first instance and after the light source has moved from the first position to a second position;
determining a second shadow to be displayed on the screen with the image generation device for augmenting the AR object at a fourth instance occurring after the third instance based at least in part on the second lighting map, the second shadow being different in shape, color and/or intensity than the first shadow;
determining a rate of change of the light source associated with moving from the first position to the second position;
generating a second image frame to be displayed on the screen with the image generation device at a fifth instance occurring after the fourth instance to facilitate presenting the AR view to include:
i) the AR object and the first shadow when the rate of change is greater than a threshold; and
ii) the AR object and the second shadow when the rate of change is equal to or less than the threshold.

8. The non-transitory computer-readable medium of claim 7 further comprising non-transitory instructions sufficient for generating the first and second image frames such that a position of the AR object appears unchanged in the AR view at the second and fifth instances.

9. The non-transitory computer-readable medium of claim 1 further comprising non-transitory instructions sufficient for:
determining the first lighting effect to be a first shadow associated with a light source positioned at a first location within the real area at the first instance;
generating a first image frame to be displayed on the screen with the image generation device at the second instance to facilitate presenting the AR view to include at least the AR object and the first shadow;
generating a second lighting map of the real area based on a second luminosity data determined for at least a portion of the real area with the light sensor at a third instance in time occurring after the first instance and after the light source has moved from the first position to a second position;
determining a second shadow to be displayed on the screen with the image generation device for augmenting the AR object at a fourth instance occurring after the third instance based at least in part on the second lighting map, the second shadow being different in shape, color and/or intensity than the first shadow;
determining a rate of change of the light source associated with moving from the first position to the second position;
determining a plurality of buffered shadows stored in a memory of the AR device, each of the plurality of buffered shadows having been previously generated for the AR object from a corresponding one of a plurality of lighting maps generated for at least a portion of the real area prior to the second instance, the plurality of buffered shadows including the first shadow;
generating a second image frame to be displayed on the screen with the image generation device at a fifth instance occurring after the fourth instance to facilitate presenting the AR view to include:
i) the AR object and the second shadow when the rate of change is less than a threshold; and
ii) the AR object and a third shadow selected from the plurality of buffered shadows when the rate of change is greater than the threshold.

10. The non-transitory computer-readable medium of claim 1 further comprising non-transitory instructions sufficient for:
determining the first lighting effect to be a first shadow associated with a light source positioned at a first location within the real area at the first instance;
generating a first image frame to be displayed on the screen with the image generation device at the second instance to facilitate presenting the AR view to include at least the AR object and the first shadow;
determining a movement of the light source from a second location to the first location, the second location corresponding with positioning of the light source within the real area at a third instance in time occurring prior to the first instance;
adjusting the first shadow based at least in part on the movement to facilitate determining a second shadow to be displayed on the screen with the image generation device for augmenting the AR object at a fourth instance occurring after the third instance; and
generating a second image frame to be displayed on the screen with the image generation device at a fifth instance occurring after the fourth instance to facilitate presenting the AR view to include the AR object and the second shadow.

11. The non-transitory computer-readable medium of claim 10 further comprising non-transitory instructions sufficient for:
generating the first shadow to darken a first surface area proximate the AR object; and
generating the second shadow to darken a second surface area proximate the AR object, the second surface area being less than the first surface area by an amount proportional to the movement.

12. The non-transitory computer-readable medium of claim 1 further comprising non-transitory instructions sufficient for:
generating a spatial coordinate system for the real area using a spatial device of the AR device, the spatial coordinate system being sufficient to facilitate determining real object positioning in the real area relative to an X, Y and Z coordinate system centered at the AR device;
generating the first lighting map as a color-temperature graph sufficient for indicating a color and an intensity of light within the real area reaching the light sensor;
determining AR object coordinates within the X, Y and Z coordinate system for the AR object associated with positioning of the AR object within the real area;
estimating a lighting influence on the AR object based an offset or other relationship between the AR object coordinates and the first lighting map, the lighting influence relating the color and the intensity of the color-temperature map to the AR object coordinates; and
generating the first lighting effect to account for the lighting influence.

13. A non-transitory computer-readable medium having a plurality of non-transitory instructions executable with a processor of an augmented reality (AR) device to facilitate presenting an AR view of a real area, the non-transitory instructions being sufficient to facilitate:
generating a first lighting map for at least a portion of the real area;
determining an AR object to be displayed in order to present the AR view of the real area; and
determining a first lighting effect to be displayed with the AR object in the AR view based at least in part on extrapolating the first lighting map to determine lighting influences on the AR object.

14. The non-transitory computer-readable medium of claim 13 further comprising non-transitory instructions sufficient for:
generating the first lighting map to represent luminosity measured for the real area at a first position proximate the AR device;
determining a second position for the AR object within the AR view; and
determining the first lighting influence by extrapolating the first lighting map based at least in part on a positional offset between the first and second positions.

15. The non-transitory computer-readable medium of claim 13 further comprising non-transitory instructions sufficient for:
determining the first lighting influence to be a first shadow;
generating the first lighting map to at least in part represent luminosity measured for the real area proximate the AR device; and
determining a first shape of the first shadow to be proportional to the luminosity measured in the first lighting map.

16. The non-transitory computer-readable medium of claim 13 further comprising non-transitory instructions sufficient for:
determining the first lighting effect to be a first shadow associated with a light source positioned at a first location within the real area at a first instance;
generating a first image frame to be displayed on a screen of the AR device with at a second instance occurring after the first instance to facilitate presenting the AR view to include at least the AR object and the first shadow;
determining a movement of the light source from a second location to the first location, the second location corresponding with positioning of the light source within the real area at a third instance in time occurring prior to the first instance;
adjusting the first shadow based at least in part on the movement to facilitate determining a second shadow to be displayed on the screen for augmenting the AR object at a fourth instance occurring after the third instance; and
generating a second image frame to be displayed on the screen at a fifth instance occurring after the fourth instance to facilitate presenting the AR view to include the AR object and the second shadow.

17. The non-transitory computer-readable medium of claim 13 further comprising non-transitory instructions sufficient for:
generating a spatial coordinate system for the real area, the spatial coordinate system being sufficient to facilitate determining real object positioning in the real area relative to an X, Y and Z coordinate system relative to the AR device;
generating the first lighting map as a color-temperature graph sufficient for indicating a color and an intensity of light within the real area;
determining AR object coordinates within the X, Y and Z coordinate system for the AR object within the real area;
estimating a lighting influence on the AR object based an offset or other relationship between the AR object coordinates and the first lighting map, the lighting influence relating the color and the intensity of the color-temperature map to the AR object coordinates; and
generating the first lighting effect to account for the lighting influence.

18. The non-transitory computer-readable medium of claim 13 further comprising non-transitory instructions sufficient for:
determining the real area to include at least a first light source and a second light source at a first instance based at least in part on the first lighting map;
determining a first angle of incidence with the AR object for a first light emitted from the first light source based at least in part on the first lighting map;
determining a second angle of incidence with the AR object for a second light emitted from the first light source based at least in part on the first lighting map; and
determining a first shape of the first lighting effect at a second instance occurring after the first instance based at least in part on the first and second angles such that the first shape represents how the first and second light sources would influence a real shadow for the AR object if the AR object was real;
generating a second lighting map of the real area for at least a portion of the real area at a third instance occurring after the second instance;
determining the AR view at a fourth instance occurring after the third instance to require the AR object to be appear stationary at least in so far as the AR object appearing in the AR view at the second and fourth instances without changing position;
determining a second lighting effect to be displayed for augmenting the AR object at the fourth instance based at least in part on the second lighting map;
determining the second lighting effect to include a second shadow;
determining a second shape of the second shadow based at least in part on the second lighting map;
determining the real area to include the first and second light sources at the third instance based at least in part on the second lighting map;
determining a third angle of incidence with the AR object for a third light emitted from the first light source based at least in part on the second lighting map, including determining the third angle to match the first angle due to a position of the first light source being the same at the first and third instances;
determining a fourth angle of incidence with the AR object for a fourth light emitted from the second light source based at least in part on the second lighting map, including determining the fourth angle to differ from the second angle due to a position of the second light source being different at the first and third instances; and
determining the second shape of the second shadow based at least in part on the third and fourth angles such that the second shape differs from the first shape by an amount sufficient to cause the second shadow to appear differently in the AR view than the first shadow.

19. A method for presenting an augmented reality (AR) view of a real area comprising:
generating a first lighting map for at least a portion of the real area with a mapping device associated with an AR device;
determining an AR object to be projected on a screen of AR device with a sensory device in order to present the AR view of the real area; and
determining a first shadow to be displayed with the AR object in the AR view based at least in part on extrapolating the first lighting map to determine lighting influences on the AR object.

20. The method of claim 19 further comprising:
generating a second lighting map for at least a portion of the real area with the mapping device after detecting movement of at least on light source in the real area; and
determining a second shadow to be displayed with the AR object in the AR view in place of the first shadow after detecting the movement based at least in part on extrapolating the second lighting map to determine lighting influences on the AR object.
